(19) United States
(12) Patent Application Publication
(10) Pub. No.: US 2018/0357006 A1
(43) Pub. Date: Dec. 13, 2018

(54) Data Processing Method, Allocation Method, Electronic Device, Client and Storage Media

(71) Applicant: Alibaba Group Holding Limited, Grand Cayman (KY)

(72) Inventor: Jianguo Tan, Hangzhou (CN)

(21) Appl. No.: 16/001,888

(22) Filed: Jun. 6, 2018

(30) Foreign Application Priority Data
Jun. 7, 2017 (CN) 201710422937.1

(51) Int. Cl. G06F 3/06

(52) U.S. Cl. CPC G06F 3/0646; G11B 20/10527; G06F 3/0673; G06F 3/0604

(57) ABSTRACT

A buffer allocation method, a data processing method, an electronic device, a client and a storage media are disclosed in the present disclosure. The data processing method include receiving a writing request of an application program, the writing request including data to be buffered and a buffer object identifier, and the buffer object identifier corresponding to a buffer object; if the data to be buffered is media data, performing designated processing on the media data to cause the media data to possess a designated effect when being displayed; and writing the media data that has gone through the designated processing into a storage region pointed by the buffer object so that media data that is used is the media data that has gone through the designated processing when the buffer object is called. The present disclosure can reduce the time and the cost required in the development of application programs.

### CROSS REFERENCE TO RELATED PATENT APPLICATIONS

This application claims priority to Chinese Patent Application No. 201710422937.1, filed on 7 Jun. 2017, entitled “Data Processing Method, Allocation Method, Electronic Device, Client and Storage Media,” which is hereby incorporated by reference in its entirety.

### TECHNICAL FIELD

The present disclosure relates to the technical field of computers, and particularly to media data processing methods, buffer object allocation methods, electronic devices, clients and storage media.

### BACKGROUND

Along with the development of society, people are getting more and more used to using electronic devices for viewing videos. Specifically, people view television shows and movies, for example, using network televisions, computers, smartphones, intelligent wearable devices, etc.

In existing technologies, an electronic device is installed with an operating system, and supports an installation of application programs through the operating system. A user can play a video by using video software or an application program that is installed. Specifically, operating systems can be an Android system (an operating system developed by) Google®), an IOS system (an operating system developed by Apple®), and a Windows system (an operating system developed by Microsoft®), for example. A video software application program, such as Youku, QQlive, iQIYI, YouTube, etc., plays a video. As the video viewing requirements of users become greater, some video application programs are integrated with video data processing modules to increase display effects of video data, such as improving the resolution of the video data, and changing the contrast ratio of the video data, etc.

Nevertheless, the existing technologies mainly have each piece of video software to integrate with a video data processing module therein, so that it is difficult for different pieces of video software to use video data processing modules of each other. In other words, during the video software development, developers of each piece of software write codes to implement video data processing functions that are integrated in that software. Development processes of different pieces of software are relatively independent with one another, thus leading to the need of members of individual teams to perform development tasks separately even though functions and effects that are implemented are basically the same.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or processor-readable/computer-readable instructions as permitted by the context above and throughout the present disclosure. A goal of embodiments of the present disclosure is to provide a better and universal media data processing method, a buffer allocation method, an electronic device, a client, and a storage media.

Implementations of the present disclosure provide a media data processing method, which includes receiving a writing request of an application program, the writing request including data to be buffered and a buffer object identifier, and the buffer object identifier corresponding to a buffer object; if the data to be buffered is media data, performing designated processing on the media data to cause the media data to possess a designated effect when being displayed; and writing the media data that has gone through the designated processing into a storage region pointed by the buffer object so that media data that is used is the media data that has gone through the designated processing when the buffer object is called.

The implementations of the present disclosure also provide a buffer object allocation method, which includes receiving a request for allocating a buffer object from an application program, wherein the request for allocating the buffer object includes a data type identifier, and the data type identifier is used for representing a data type of data of the application program to be buffered; and allocating a cached buffer object to the application program if the data type represented by the data type identifier is media data, wherein data stored in a storage region that is pointed by the cached buffer object first enters into a cache of a central processing unit before being processed by the central processing unit, and the central processing unit reads the data from the cache.

The implementations of the present disclosure further provide a computer readable storage media, on which a computer program is stored. The computer program, when executed by a processor, implements the following operations: receiving a writing request of an application program, the writing request including data to be buffered and a buffer object identifier, and the buffer object identifier corresponding to a buffer object; if the data to be buffered is media data, performing designated processing on the media data to cause the media data to possess a designated effect when being displayed; and writing the media data that has gone through the designated processing into a storage region pointed by the buffer object so that media data that is used is the media data that has gone through the designated processing when the buffer object is called.

The implementations of the present disclosure further provide a client, which includes a receiving module used for receiving a writing request of an application program, the writing request including data to be buffered and a buffer object identifier, and the buffer object identifier corresponding to a buffer object; a processing module used for, if the data to be buffered is media data, performing designated processing on the media data to cause the media data to possess a designated effect when being displayed; and a writing module used for writing the media data that has gone through the designated processing into a storage region pointed by the buffer object so that media data that is used is the media data that has gone through the designated processing when the buffer object is called.

The implementations of the present disclosure further provide an electronic device, which includes a storage device, and a processor. The storage device is used for storing computer program instructions. The processor is used for executing the computer program instructions to implement: receiving a writing request of an application program, the writing request including data to be buffered and a buffer object identifier, and the buffer object identifier corresponding to a buffer object; if the data to be buffered is media data, performing designated processing on the media data to cause the media data to possess a designated effect when being displayed; and writing the media data that has gone through the designated processing into a storage region pointed by the buffer object so that media data that is used is the media data that has gone through the designated processing when the buffer object is called.

The implementations of the present disclosure further provide a computer readable storage media, on which a computer program is stored. The computer program, when executed by a processor, implements the following operations: receiving a request for allocating a buffer object from an application program, wherein the request for allocating the buffer object includes a data type identifier, and the data type identifier is used for representing a data type of data of the application program to be buffered; and allocating a cached buffer object to the application program if the data type represented by the data type identifier is media data, wherein data stored in a storage region that is pointed by the cached buffer object first enters into a cache of a central processing unit before being processed by the central processing unit, and the central processing unit reads the data from the cache.

The implementations of the present disclosure further provide a client, which includes a receiving module used for receiving a request for allocating a buffer object from an application program, wherein the request for allocating the buffer object includes a data type identifier, and the data type identifier is used for representing a data type of data of the application program to be buffered; and an allocation module used for allocating a cached buffer object to the application program if the data type represented by the data type identifier is media data, wherein data stored in a storage region that is pointed by the cached buffer object first enters into a cache of a central processing unit when being processed by the central processing unit, and the central processing unit reads the data from the cache.

The implementations of the present disclosure further provide an electronic device, which includes a storage device, and a processor. The storage device is used for storing computer program instructions. The processor is used for executing the computer program instructions to implement: receiving a request for allocating a buffer object from an application program, wherein the request for allocating the buffer object includes a data type identifier, and the data type identifier is used for representing a data type of data of the application program to be buffered; and allocating a cached buffer object to the application program if the data type represented by the data type identifier is media data, wherein data stored in a storage region that is pointed by the cached buffer object first enters into a cache of a central processing unit before being processed by the central processing unit, and the central processing unit reads the data from the cache.

As can be seen from the technical solutions provided by the embodiments of the present disclosure as described above, the implementations of the present disclosure improve an operating system, so that the operating system can perform processing specifically for media data of an application program to cause the media data to possess a specific effect when being displayed. Since the operating system is basic functional software of an electronic device, and applications installed in the electronic device all receive support based on the operating system, the media data processing method can have a very widespread universality. The application programs that are installed in the electronic device can use the media processing method of the operating system without the need of integrating with any specialized video data processing algorithm, audio data processing algorithm, or image data processing algorithm, etc. Therefore, this brings convenience to application program developers, and can achieve a reduction in the cost of software development in the entire society to a certain extent, thus improving the efficiency of software development of the entire society.

### BRIEF DESCRIPTION OF THE DRAWINGS

In order to describe the technical solutions of embodiments of the present disclosure in a better manner, accompanying drawings that are needed in the description of the embodiments are briefly described herein. Apparently, the accompanying drawings described herein merely represent some embodiments recorded in the present disclosure. Based on these accompanying drawings, one of ordinary skill in the art can also obtain other drawings without making any creative effort.

FIG. 1 is a flowchart of a media data processing method provided in an implementation of the present disclosure.

FIG. 2 is a flowchart of a media data processing method provided in the implementations of the present disclosure.

FIG. 3 is a flowchart of a media data processing method provided in the implementations of the present disclosure.

FIG. 4 is a flowchart of a buffer object allocation method provided in the implementations of the present disclosure.

FIG. 5 is a flowchart of a media data processing method provided in the implementations of the present disclosure.

FIG. 6 is a flowchart of a media data processing method provided in the implementations of the present disclosure.

FIG. 7 is a schematic diagram of a client provided in the implementations of the present disclosure.

FIG. 8 is a schematic diagram of a client provided in the implementations of the present disclosure.

FIG. 9 is a schematic diagram of an electronic device provided in the implementations of the present disclosure.

### DETAILED DESCRIPTION

The technical solutions in the embodiments of the present disclosure are described clearly and completely hereinafter in conjunction with the accompanying drawings in the embodiments of the present disclosure. Apparently, the described embodiments represent some and not all of the embodiments of the present disclosure. Based on the embodiments in the present disclosure, all other embodiments that are obtained by one of ordinary skill in the art without making any creative effort shall fall in the scope of protection of the present disclosure.

The implementations of the present disclosure provide a media data processing method. The method is applied in an electronic device, and is used for processing media data in the electronic device.

In the present implementation, the media data processing method is suitable for use in an operating system of an electronic device. As being a basic functional platform of the electronic device, the operating system provides support to application programs that installed in the electronic device. As such, the media data processing method can have a widespread universality. Different application programs that are installed in the electronic device can process media data through the media data processing method in the operating system, thus achieving a reduction in repeated labor of the entire society.

In the present implementation, the electronic device can be a computing device that possesses data computing and storage capabilities. Specifically, the electronic device can include a desktop computer, a laptop computer, a tablet computer, a smartphone, a personal digital assistant, an intelligent wearable device. The intelligent wearable device can include smart glasses, a smartwatch, a smart band, etc.

In the present implementation, the operating system can be a program that can run in the electronic device and can control and manage hardware and software resources in the electronic device. In the present implementation, the media data processing method can be suitable for use in an Android system (an operating system developed by Google®), an IOS system (an operating system developed by Apple®), and a Windows system (an operating system developed by Microsoft®. Furthermore, the media data processing method can be suitable for use in operating systems that are further improved or customized from the above system, such as MIUI (a mobile phone operating system developed by Xiaomi based on the Android system), EMUI (a mobile phone operating system developed by Huawei based on the Android system), etc. In a specific implementation, the media data processing method is particularly suitable for use in the Android system.

The media data processing method provided by the implementations of the present disclosure is suitable for use in a producer-consumer framework. In the producer-consumer framework, a buffer object queue can be used as a channel for communications between a producer and a consumer. In other words, the producer performs storing in the buffer object queue, and the consumer obtains data from the buffer object queue to perform corresponding processing. The media data processing method can write data provided by the producer into a storage region pointed by a buffer object after designated processing is performed, and place the buffer object into the buffer object queue, thereby allowing the consumer to use and process. Therefore, this realizes data obtained by the consumer to be data that has gone through processing by the media data processing method. The producer can be an application program that runs in the electronic device, and the consumer can be a display driver module, an audio driver module, etc., of the electronic device.

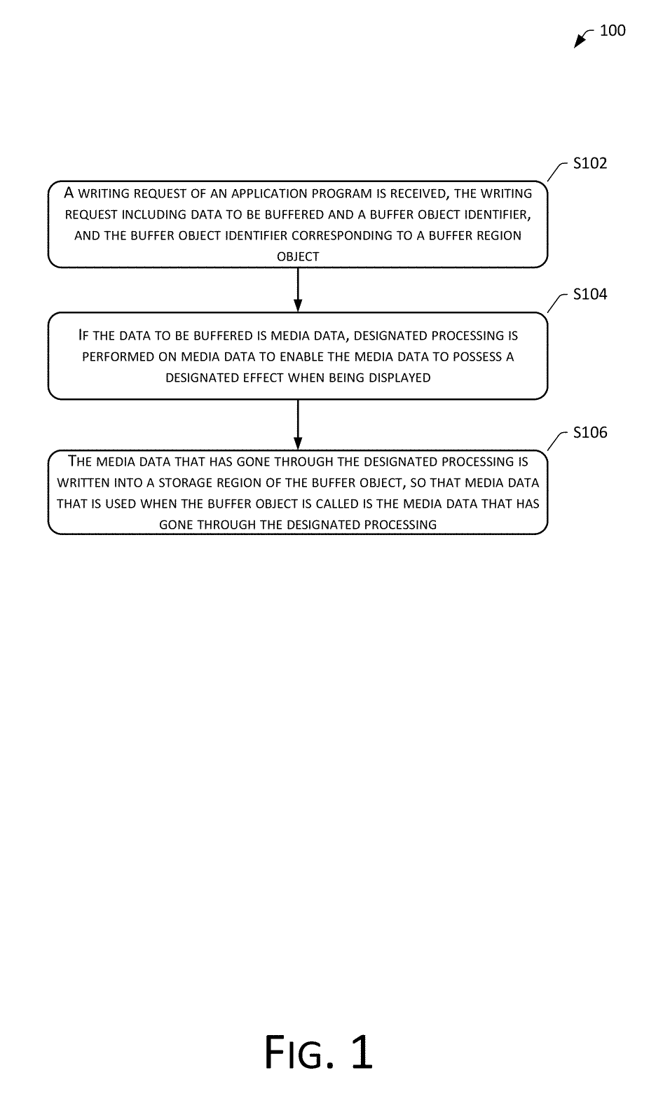

Referring to FIG. 1, the media data processing method 100 provided by the implementations of the present disclosure can include the following operations.

S102: A writing request of an application program is received, the writing request including data to be buffered and a buffer object identifier, and the buffer object identifier corresponding to a buffer region object.

In the present implementation, an application program can be a software program that runs in an operating system. The application program can respond to an operation of a user, and provide a command-defined function to the user. Specifically, an application program can be video software, audio software, and image software. The video software can be software that involves or possesses a video data playing function. The audio software can be software that involves or possesses an audio data playing function. The image software can be software that involves or possesses an image data displaying function. For example, the application program can be Youku Tudou, iQYI, QQlive, QQMusic, LeTV, KuGou, mobile phone jingdong, WeChat, QQ, etc., which is not exhaustively listed.

In the present implementation, a way of receiving a writing request by an operating system can be an application program calling an interface function provided by the operating system. When the operating system is called through the interface function thereof, this can be recognized as receiving a writing request. The operating system can provide a plurality of interface functions, with each interface function corresponding to a different function. As such, the operating system can be allowed to perform corresponding processing according to different interface functions that are called. Furthermore, the operating system may provide one or more interface functions. When calling an interface function, an application program provides a function identifier, so that the operation system can identify a different request based on the function identifier. For example, the operating system provides an interface function corresponding to receiving a writing request. When the interface function is called, the operating system can recognize that a writing request is received.

In the present implementation, data to be buffered can be data outputted by an application program when running. This data can be used for consumption by a consumer. The data to be buffered can include, but is not limited to, textual data, video data, audio data, image data, etc. For example, the application program is video software, and video data outputted thereby can be provided to a display driver module of an electronic device through a buffer object, to be displayed in a display.

In the present implementation, a buffer object can be a data object having a defined data structure. The buffer object can be defined using a software command. When a software function is needed, instantiation is performed according to a software command corresponding to a buffer object. A buffer object can possess a storage region, and the storage region can be used for storing data. In other words, a storage region of each buffer object can be used as a buffer region of data. A buffer object can possess a defined property. A storage region of the buffer object can be implemented through the property. For example, a starting address and an ending address of a storage region can be treated as properties of a buffer object. Specific values of a starting address and an ending address restrict an actual size of a buffer. Apparently, properties of a buffer object are not limited to what are described above. Properties of a buffer object may also include a buffer object type identifier, a data type identifier, etc. Apparently, one skilled in the art can also set up other properties for a buffer object under the inspiration of the technical essence of the implementations of the present disclosure. However, as long as implemented functions and effects thereof are identical or similar to the present disclosure, they should also be covered by the scope of protection of the present disclosure.

In the present implementation, a buffer object identifier is used for identifying a buffer object to facilitate invocation and further processing of the buffer object. Each buffer object can be an independent data unit, and buffer objects can be distinguished through buffer object identifiers. For example, a buffer object identifier can be “Buffer 1”.

In the present implementation, a writing request of an application program can be used for notifying an operating system to write data to be buffered into a storage region that is pointed by a buffer object. As such, a communication mechanism between the application program and the operating system is implemented. The application program sends the writing request through the operating system, so that the application program can hand over data to be buffered to the operating system. Furthermore, by including a buffer object identifier in the writing request, an existence of a correspondence relationship between a buffer object and the application program is achieved. As such, interactions between the operating system and the application program can be more standardized, and a flow thereof can be smooth.

S104: If the data to be buffered is media data, designated processing is performed on media data to enable the media data to possess a designated effect when being displayed.

In the present implementation, media data can be data that can be displayed in a physical layer of an electronic device, for example, video data and images displayed by the electronic device through a display, and audio data played by a loudspeaker. Media data can be used for transmitting certain information to a user, thereby achieving a certain interaction between an application program and the user. In a specific implementation, media data can include video data, audio data, and image data. Apparently, under the inspiration of the technical essence of the present disclosure, one skilled in the art can also apply other data in the processing method provided by the present disclosure, which should be covered in the scope of protection of the present disclosure as long as implemented functions and effects are identical or similar to the present disclosure.

In the present implementation, an operating system can determine a data type of data to be buffered, and thereby can perform corresponding processing for different data types of data to be buffered. For example, a writing request may also include a data type identifier, and the data type identifier is used for representing a data format of data to be buffered. An operating system can determine whether the data to be buffered is media data based on the data type identifier. Alternatively, a buffer object corresponding to a buffer object identifier of a writing request possesses a property representing a writable data type of a storage region, and a value of this property represents the writable data type is media data. Therefore, when the buffer object is allocated to an application program, a data format of data to be buffered can be appointed, so that an operating system can recognize whether the data to be buffered is the media data by determining the value of the property of the buffer object.

In the present implementation, designated processing may be a corresponding algorithm integrated in an operating system for performing corresponding processing on media data to cause the media data to possess an expected effect when being displayed. Corresponding to specific data types of media data, an operating system can be configured with different algorithms. Alternatively, corresponding to media data of a same data type, an operating system can also be integrated with different algorithms, so that the media data can be enabled to have different display effects. For example, for processing of video data, processing of each image frame of the video data, e.g., sharpening, blurring, saturation processing, contrast processing, pixel changing processing, image cropping, etc., can be performed. For processing of an image, references can be made to the processing on each image in video data. For processing of audio data, processing of amplitude and frequency of the audio data can be performed, e.g., increasing the amplitude of a certain sound frequency, decreasing the amplitude of a certain sound, changing a frequency of a certain sound, etc.

In the present implementation, by performing designated processing on media data, the processed media data is different from the original media data, and therefore the processed media data possesses a display effect that is different from that of the original media data when being displayed. This difference in the display effects manifest a designated effect brought about by the designated processing. For example, video data or image data becomes visually clearer after processing, and audio data becomes acoustically clearer after processing.

S106: The media data that has gone through the designated processing is written into a storage region of the buffer object, so that media data that is used when the buffer object is called is the media data that has gone through the designated processing.

In the present implementation, buffer region points to a storage region. It can be understood as a buffer object having a corresponding storage region. When a buffer object is instantiated, an operating system can assign a specific storage region to the buffer object. Alternatively, only the operating system assigns the specific storage region to the buffer object when a writing request for the buffer object is received. A starting address and an ending address in the properties of the buffer object can be treated as a starting point and an ending point of physical addresses of the storage region. As such, a difference between the starting address and the ending address can be treated as an actual capacity of the storage region.

In the present implementation, a storage region can be located in an internal memory of an electronic device. An operating system can provide a region in the internal memory to a buffer object for storing data of an application program corresponding to the buffer object.

In the present implementation, a buffer object can act as a communication channel between a producer and a consumer. In other words, a producer stores data into a storage region pointed by a buffer object so that the data can be provided to a corresponding consumer. In the present implementation, the data of the producer to be buffered can be written into the storage region pointed by the buffer object only after going through the designated processing. As such, when the consumer obtains the buffer object and reads the data of the corresponding storage region, the data obtained by the consumer is the data that has gone through the designated processing. For example, video software provides video data to be buffered to an operating system, and the operating system writes each image frame in the video data into a storage region pointed by a corresponding buffer object after performing blurring processing. The operating system can then place the buffer object into a buffer object queue. When needed, the operating system extracts the buffer object from the buffer object queue and provides the buffer object to a display driver module. For example, the display driver module may be GPU (Graphics Processing Unit) and related computing commands, and can read the video data in the storage region pointed by the buffer object, thereby performing necessary processing prior to displaying in a display. In this case, the video data read by the display driver module is the data that has gone through the blurring processing.

The implementations of the present disclosure make improvements to an operating system based on a pattern of a producer-consumer framework. The operating system is enabled to perform processing that is specific to media data of an application program, and allow the media data to possess a defined effect when being displayed. Since the operating system is basic functional software of an electronic device, and applications installed in the electronic device all receive support based on the operating system, the media data processing method can have a very widespread universality. The application programs that are installed in the electronic device can use the media processing method of the operating system without the need of integrating with any specialized video data processing algorithm, audio data processing algorithm, or image data processing algorithm, etc. Therefore, this brings convenience to application program developers, and can achieve a reduction in the cost of software development in the entire society to a certain extent, thus improving the efficiency of software development of the entire society.

In an implementation, the media data may be video data, audio data or image date. Correspondingly, in the operation of performing the designated processing on the data in the buffer, processing that increases display effects of the video data is performed to enable the video data to possess designated visual effects when being played. Alternatively, processing that increases audio effects of the audio data is performed to enable the audio data to possess designated acoustic effects when being played. Alternatively, processing that increases display effects of the image data is performed to enable the image data to possess designated visual effects when being displayed.

In the present implementation, an operating system can set up different processing algorithms for different media data to enable the operating system to possess a widespread universality. For example, for processing of video data, processing of each image frame of the video data, e.g., sharpening, blurring, saturation processing, contrast processing, pixel changing processing, image cropping, etc., can be performed. For processing of an image, references can be made to the processing on each image in video data. For processing of audio data, processing of amplitude and frequency of the audio data can be performed, e.g., increasing the amplitude of a certain sound frequency, decreasing the amplitude of a certain sound, changing a frequency of a certain sound, changing a data format of the audio data, changing a data frequency of the audio data, etc.

Apparently, when an operating system receives a writing request of an application program, the writing request may include a way-of-processing identifier. The way-of-processing identifier can be used for representing a way of processing of data to be buffered in the writing request. For example, the data to be buffered is video data, and the way-of-processing identifier can represent blurring processing to improve the visual resolution of the video data when being displayed.

In an implementation, the buffer object can include a buffer object type identifier. The buffer object type identifier is used for representing a type of the buffer object. The media data processing method may further include writing the data to be buffered into a storage region pointed by the buffer object corresponding to the buffer object type identifier. Correspondingly, the operation of performing the designated processing on the media data includes recognizing the data to be buffered to be media data when a type of buffer object represented by the buffer object type identifier is a cached buffer object, wherein data stored in a storage region that is pointed by the cached buffer object first enters into a cache of a central processing unit (CPU) before the central processing unit (CPU) performs the designated processing thereon, the central processing unit (CPU) reading the data from the cache.

In the present implementation, buffer objects may be classified first, and media data can be made to correspond to a type of a buffer object. As such, when allocating a buffer object to an application program, an operating system can allocate a corresponding buffer object based on a cached object type provided by the application program. Specifically, for data to be buffered being media data, a cached buffer object can be allocated. As such, when a buffer object is recognized to be a cached buffer object, data to be buffered in a writing request can be recognized to be media data.

In the present implementation, a buffer object that is allocated by an operating system for media data can be cached buffer object, because data in a storage region of a cached buffer object is first called into a cache of a central processing unit before the central processing unit performs the designated processing. A cache is a high speed memory, having a very fast read and write speed. As such, when the central processing unit performs processing on the media data, it can be completed in a shorter time. Therefore, the workload brought about by performing designated processing can be reduced, and the influence on response speed of an electronic device is reduced.

In the present implementation, a buffer object type identifier can be a predefined character string, which can have a defined format. For example, a buffer object type identifier can use “cacheable” to represent a cached buffer object, and “noncacheable” to represent non-cached buffer object. Data in a storage region of a non-cached buffer object, when processed by a central processing unit, can be read and processed directly by the central processing unit from an internal memory without first entering into a cache of the central processing unit.

In an implementation, the writing request further includes a data type identifier. The data type identifier is used for representing a data format of the data to be buffered. The media data processing method may include recognizing a data type of data in the buffer to be media data when a data format represented by the data type identifier is video data, audio data or image data.

In the present implementation, a writing request can include a data type identifier. As such, this helps an operating system to determine whether designated processing is needed to be performed for buffered data included in the writing request.

In the present implementation, a data type identifier can possess a defined format. For example, a specific value of a data type identifier can be “YV12” or “NV12”, etc. After receiving a writing request and finding that a data type identifier is YV12, an operating system can recognize data to be buffered is media data, thereby helping the operating system to perform determination. Similarly, for audio data and image data, data type identifiers can also be appointed with respective values of the audio data or the image data.

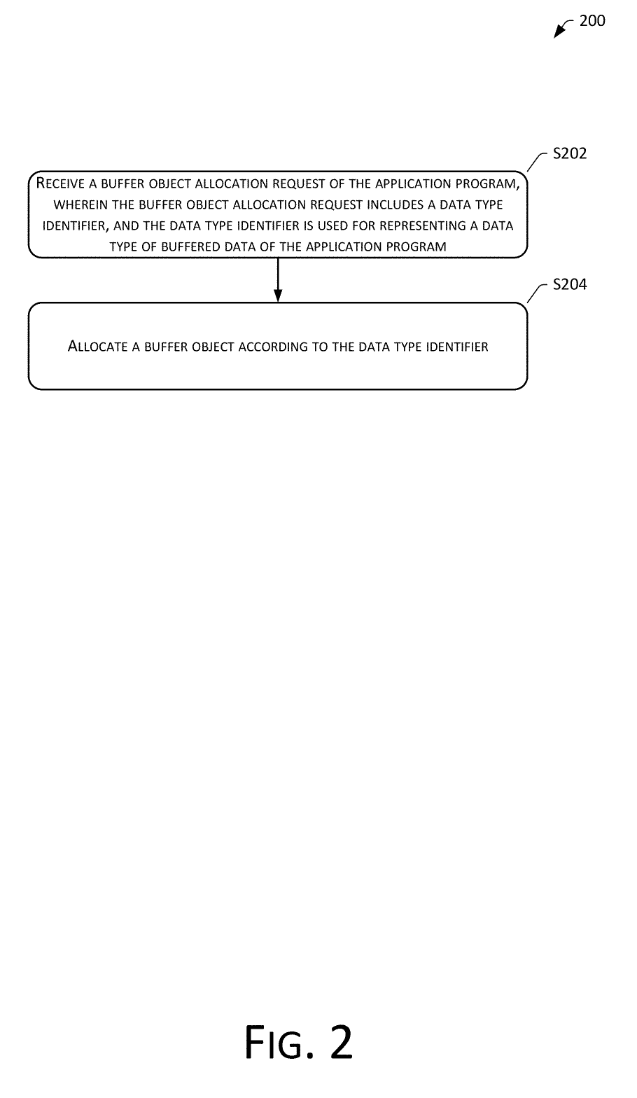

Referring to FIG. 2, the implementations of the present disclosure further provide a buffer object allocation method 200. The buffer object allocation method 200 can be applied before the media data processing method. The buffer object allocation method 200 may include the following operations.

S202 receives a buffer object allocation request of the application program, wherein the buffer object allocation request includes a data type identifier, and the data type identifier is used for representing a data type of buffered data of the application program.

S204 allocates a buffer object according to the data type identifier.

In the present implementation, a manner of receiving a buffer object allocation request by an operating system may be an application program calling an interface function provided by the operating system. When the operating system is called through the interface function thereof, this can be recognized as receiving a buffer object allocation request. The operating system can provide a plurality of interface functions, with each interface function corresponding to a different function. As such, the operating system can be allowed to perform corresponding processing according to different interface functions that are called. Furthermore, the operating system may provide one or more interface functions. When calling an interface function, an application program provides a function identifier, so that the operation system can identify a different request based on the function identifier. For example, the operating system provides an interface function. When an application program calls the interface function, a function identifier that is provided is “alloc”. Upon receiving this function identifier, the operating system can recognize that a buffer object allocation request is received.

In the present implementation, buffer objects can include a cached buffer object and a non-cached buffer object. Data in a storage region of a cached buffer object can first be called into a cache of a central processing unit and the central processing unit reads the data from the cache, before being processed by the central processing unit. Since the cache is a high speed memory having a very fast read and write speed, data in a storage region of a cached buffer object can have a relatively fast processing speed of response. Data in a storage region of a non-cached buffer object does not need to enter into a cache of a central processing unit before being processed by the central processing unit, and the central processing unit directly read data from an internal memory in which the non-cached buffer object is located. A processing speed thereby is lower than that of reading data from a cache.

In the present implementation, data of an application program to be buffered may be media data or non-media data. For media data, an operating system can allocate a cached buffer object for the application program. For non-media data, the operating system can allocate a non-cached buffer object for the application program. Specifically, media data can be video data, audio data, or image data, for example. When data type identifier represents that buffered data is video data, audio data or image data, the operating system can allocate a cached buffer to the application program.

In the present implementation, a manner of allocating a buffer object to an application program by an operating system may include generating a new buffer object for providing to the application program by the operating system. Alternatively, the operating system may further examine whether buffer object(s) that is/are in an idle state exist(s) in buffer objects that have been generated, and provide a buffer object that is in an idle state to the application program. For example, the operating system generates a cached buffer object for media data. For non-media data, the operating system may generate a non-cached buffer object. Apparently, for non-media data, specific allocation of a buffer object needs to be made according to specific service needs. Alternatively, for media data, the operating system examine whether cached buffer object(s) that is/are in an idle state exist(s) in cached buffer objects that have been generated, and provide a cached buffer object that is in an idle state to the application program.

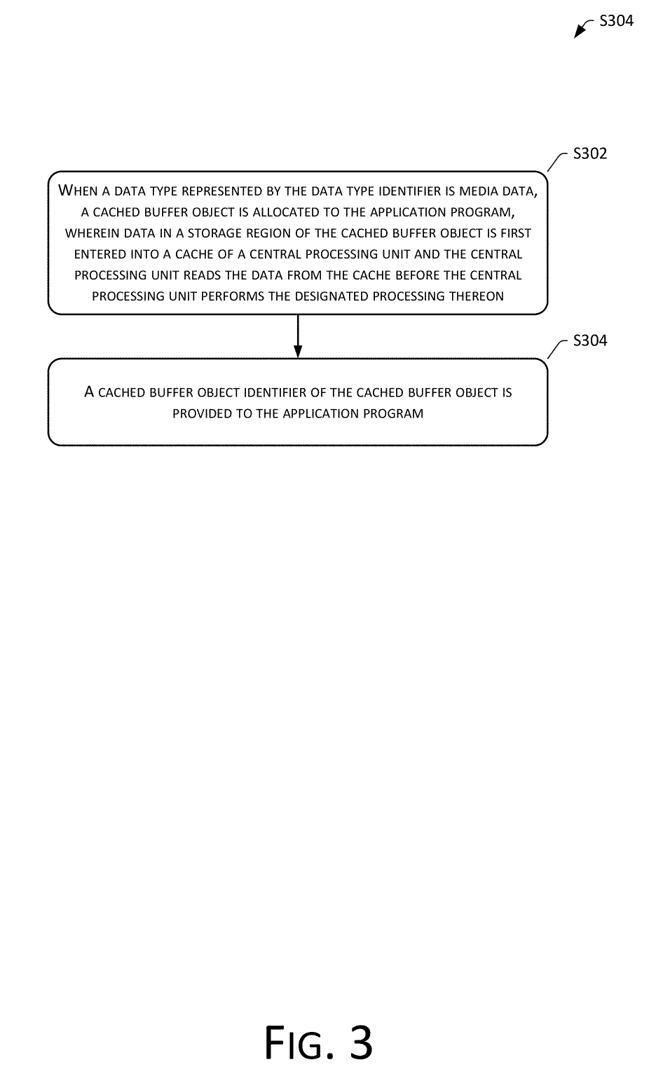

Referring to FIG. 3, in an implementation, the operation S204 of allocating the buffer object according to the data type identifier may include the following operations.

S302: When a data type represented by the data type identifier is media data, a cached buffer object is allocated to the application program, wherein data in a storage region of the cached buffer object is first entered into a cache of a central processing unit and the central processing unit reads the data from the cache before the central processing unit performs the designated processing thereon.

S304: A cached buffer object identifier of the cached buffer object is provided to the application program.

In the present implementation, the operating system determines whether the data to be buffered is media data based on a data type identifier. The operating system allocates a cached buffer object for media data, so that processing is relatively faster when the designated processing is performed on the media data. This avoids an entire response to become too long due to performing the designated processing on the media data.

In the present implementation, a buffer object identifier is used for identifying a buffer object. By providing a buffer object identifier of a cached buffer object to an application program, the application program can obtain and know the corresponding cached buffer object, and thereby can write data to be buffered into a storage region of the buffer object using the buffer object identifier.

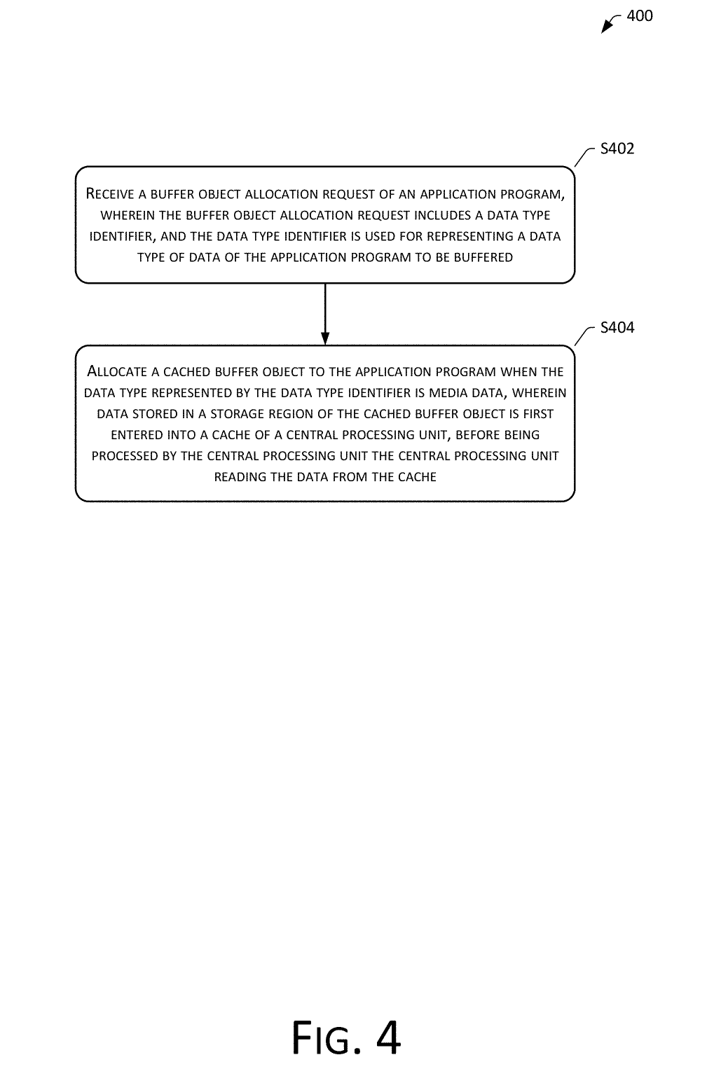

Referring to FIG. 4, the implementations of the present disclosure further provide a buffer allocation method 400, which includes the following operations.

S402 receives a buffer object allocation request of an application program, wherein the buffer object allocation request includes a data type identifier, and the data type identifier is used for representing a data type of data of the application program to be buffered.

S404 allocates a cached buffer object to the application program when the data type represented by the data type identifier is media data, wherein data stored in a storage region of the cached buffer object is first entered into a cache of a central processing unit, before being processed by the central processing unit the central processing unit reading the data from the cache.

In the present implementation, the detailed content of the buffer allocation method can be referenced to the above implementations for explanation, and is not repeatedly described herein.

In a specific example scenario, an electronic device may be a smartphone. An operating system running in the smartphone may be an Android system. The smartphone is installed with video playing software, and supports the running of the video playing software through the Android system.

In the present example scenario, a user operates on the smartphone to start the video playing software for viewing a video. After the video playing software is started, corresponding video data is obtained according to operations of the user. The video data of the video playing software needs to be provided to a display driver module through a buffer object queue of the operating system. As such, the display driver module can control a display for visually displaying the video data.

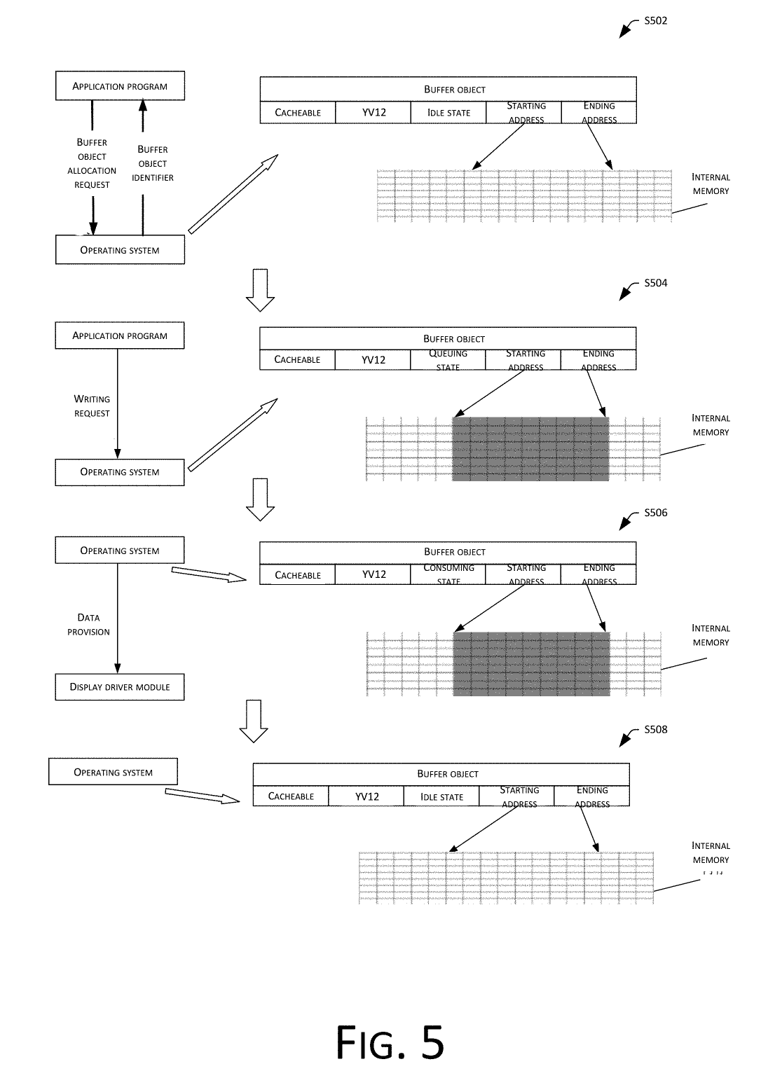

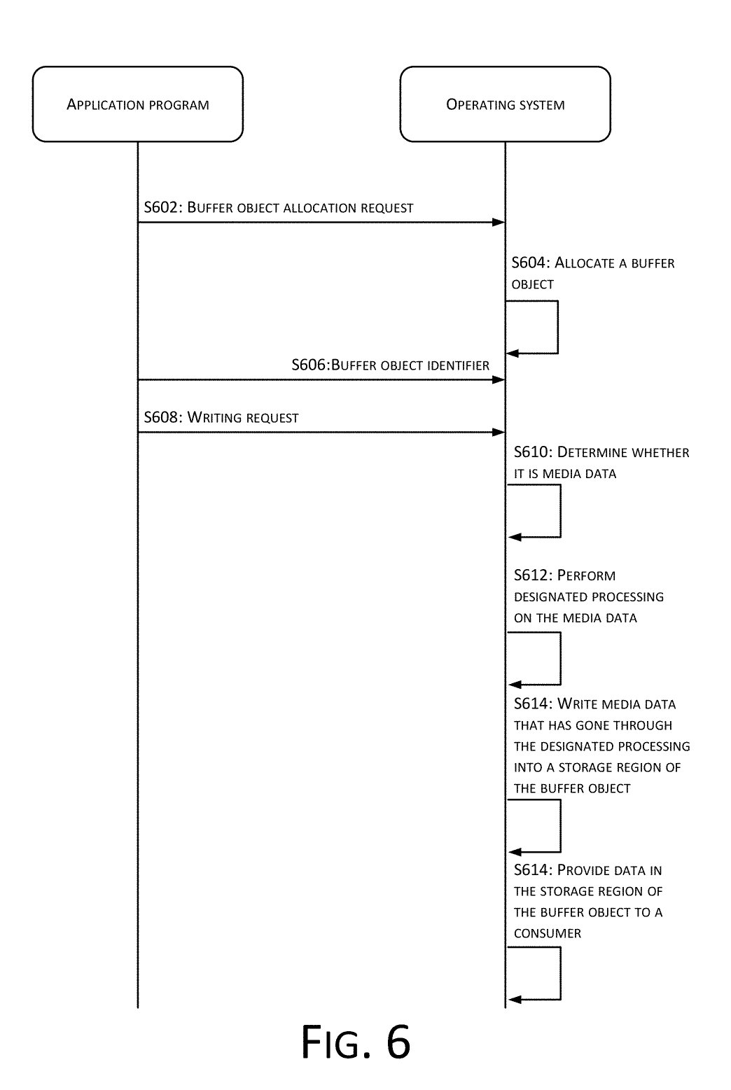

Referring to FIG. 5 and FIG. 6, in the present example scenario, the video playing software sends a buffer allocation request to the operating system at S602. The buffer object request includes a data type identifier “YV12”. In response to receiving the buffer allocation request, the operating system can recognize data of the video playing software to be buffered is media data based on the data type identifier “YV12”. The operating system calls a relevant method to instantiate a buffer object at S604. When a buffer object is instantiated, there is a buffer object identifier. The buffer object can be called through this buffer object identifier. The buffer object includes a buffer object type identifier, a data type identifier, a state identifier, a starting address, and an ending address. A storage region of the buffer object is bounded by the starting address and the ending address. A value of the buffer object type identifier can be “cacheable”, to represent that the buffer object is a cached buffer at S502. A value of the state identifier is an “idle state”. A value of the data type identifier is “YV12”. Values of the starting address and the ending address are internal memory addresses, which are not repeatedly described herein. The operating system provides the buffer object identifier of the buffer object to the video playing software at S606.

In the present example scenario, the video playing software sends a writing request to the operating system at S608. The writing request includes data to be buffered and a buffer object identifier, to notify the operating system to write the data to be buffered into a storage region of a buffer object represented by the buffer object identifier. In response to receiving the writing request, the operating system writes the data to be buffered into the storage region of the buffer object that is represented by the buffer object identifier.

In the present example scenario, the operating system can recognize that the buffer object is a cached buffer object based on a buffer object type identifier of the buffer object. In order to avoid the operating system from allocating cached buffer objects to other data types, the operating system may further determine a data type identifier of the buffer object, and confirm that a data type represented by the data type identifier is media data such as video data at S610. The operating system identifies that the data to be buffered is media data, and determine that the data to be buffered is video data. The operating system reads the data to be buffered from the storage region of the buffer object, and writes the data to be buffered into a cache of a central processing unit. The central processing unit reads the data to be buffered from the cache, and performs designated processing such as sharpening processing on the data to be buffered at S612, which can have a clearer visual effect when being provided and displayed to a user at a later time at S614. The operating system writes the data to be buffered that has gone through the sharpening processing into the storage region of the buffer object.

In the present example scenario, after the data to be buffered is completely written into the storage region of the buffer object, the operating system changes state information of the cached buffer object to “queuing state”, so that the cached buffer object enters into a cached buffer object queue at S504. Furthermore, the operating system provides a buffer object identifier of the cached buffer object to a display driver module to allow the display driver module to read data in the storage region of the cached buffer object and thus control a display for visualized presentation, and changes the state information of the cached buffer object to “consuming state” at S506.

In the present example scenario, when the display driver module finishes processing the data in the storage region of the buffer object, the data in the storage region may be cleared. The operating system can change the state information of the buffer object to the “idle state” at S508.

The implementations of the present disclosure further provide a computer readable storage media, on which a computer program is stored.

In the present embodiment, the computer program, when executed by processor(s), can implement the following operations:

receiving a writing request of an application program, the writing request including data to be buffered and a buffer object identifier, and the buffer object identifier corresponding to a buffer object; if the data to be buffered is media data, performing designated processing on the media data to cause the media data to possess a designated effect when being displayed; and writing the media data that has gone through the designated processing into a storage region pointed by the buffer object so that media data that is used is the media data that has gone through the designated processing when the buffer object is called.

In the present implementation, details of functions and methods implemented by the computer program can be referenced to the foregoing embodiments for explanation, and are not repeatedly described herein.

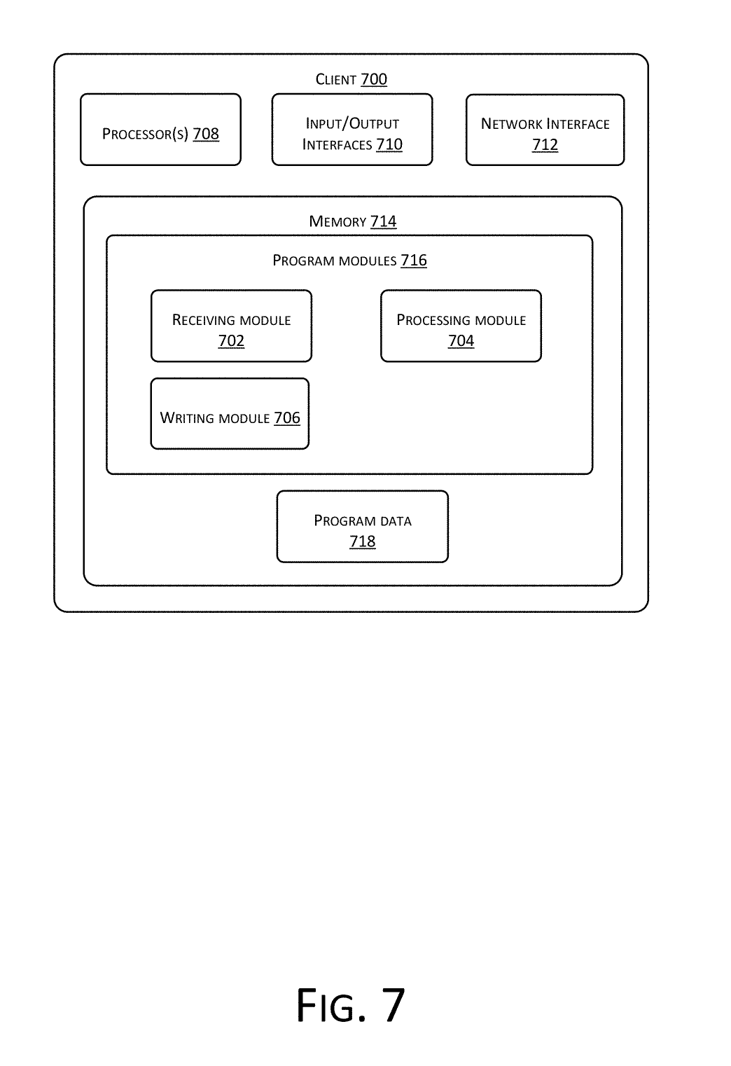

Referring to FIG. 7, the implementations of the present disclosure further provide a client 700. In implementations, the client 700 may include one or more computing devices. In implementations, the client 700 may be a part of one or more computing devices which are located in a single place or distributed among a plurality of network devices over a network. The client 700 includes a receiving module 702, a processing module 704, and a writing module 706.

The receiving module 702 is used for receiving a writing request of an application program, the writing request including data to be buffered and a buffer object identifier, and the buffer object identifier corresponding to a buffer object.

The processing module 704 is used for, if the data to be buffered is media data, performing designated processing on the media data to cause the media data to possess a designated effect when being displayed.

The writing module 706 is used for writing the media data that has gone through the designated processing into a storage region pointed by the buffer object so that media data that is used is the media data that has gone through the designated processing when the buffer object is called.

In implementations, the client 700 may further include one or more processors 708, an input/output (I/O) interface 710, a network interface 712, and memory 714.

The memory 714 may include a form of computer readable media such as a volatile memory, a random access memory (RAM) and/or a non-volatile memory, for example, a read-only memory (ROM) or a flash RAM. The memory 714 is an example of a computer readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In implementations, the memory 714 may include program modules 716 and program data 718. The program modules 716 may include one or more of the modules as describe above.

In the present implementation, details of functions and methods implemented by the client can be referenced to the foregoing embodiments for explanation, and are not repeatedly described herein.

The implementations of the present disclosure provide a computer readable storage media, on which a computer program is stored. The computer program, when executed by processor(s), implements the following operations: receiving a request for allocating a buffer object from an application program, wherein the request for allocating the buffer object includes a data type identifier, and the data type identifier is used for representing a data type of data of the application program to be buffered; and allocating a cached buffer object to the application program if the data type represented by the data type identifier is media data, wherein data stored in a storage region that is pointed by the cached buffer object first enters into a cache of a central processing unit before being processed by the central processing unit, and the central processing unit reads the data from the cache.

In the present implementation, details of functions and methods implemented by the computer program can be referenced to the foregoing embodiments for explanation, and are not repeatedly described herein.

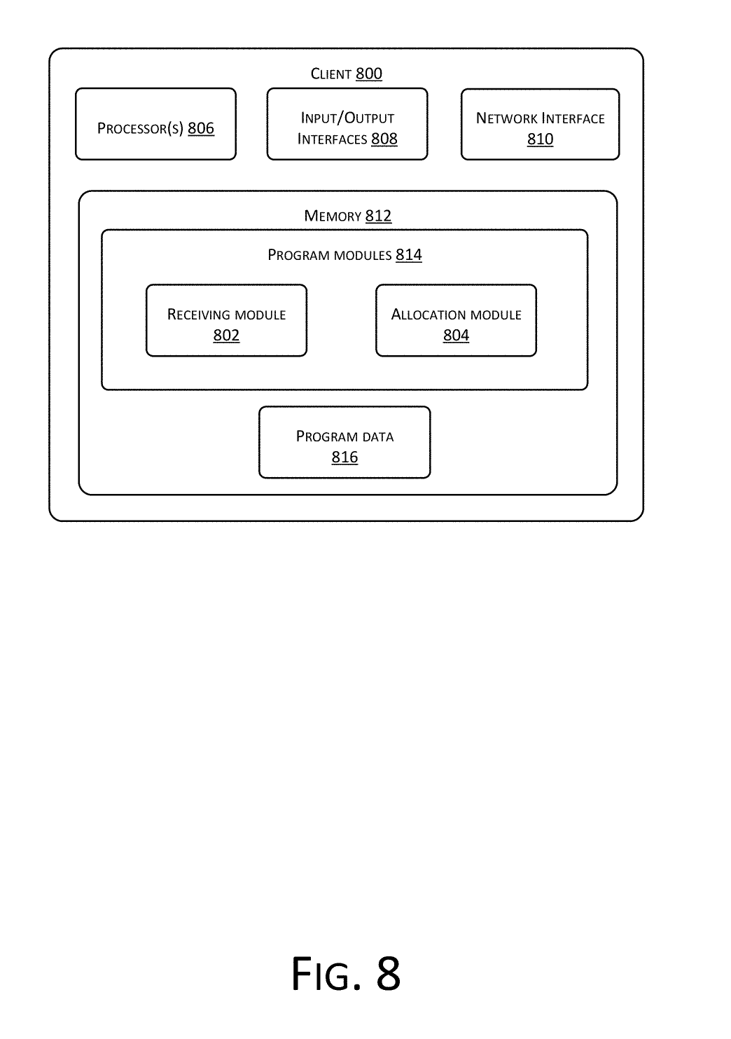

Referring to FIG. 8, the implementations of the present disclosure further provide a client 800. In implementations, the client 800 may include one or more computing devices. In implementations, the client 800 may be a part of one or more computing devices which are located in a single place or distributed among a plurality of network devices over a network. The client 800 includes a receiving module 802 and an allocation module 804.

The receiving module 802 is used for receiving a request for allocating a buffer object from an application program, wherein the request for allocating the buffer object includes a data type identifier, and the data type identifier is used for representing a data type of data of the application program to be buffered.

The allocation module 804 is used for allocating a cached buffer object to the application program if the data type represented by the data type identifier is media data, wherein data stored in a storage region that is pointed by the cached buffer object first enters into a cache of a central processing unit before being processed by the central processing unit, the central processing unit reading the data from the cache.

In implementations, the client 800 may further include one or more processors 806, an input/output (I/O) interface 808, a network interface 810, and memory 812. The memory 812 may include a form of computer readable media as described in the foregoing description.

In the present implementation, details of functions and methods implemented by the client can be referenced to the foregoing embodiments for explanation, and are not repeatedly described herein.

In implementations, the memory 812 may include program modules 814 and program data 816. The program modules 814 may include one or more of the modules as describe above.

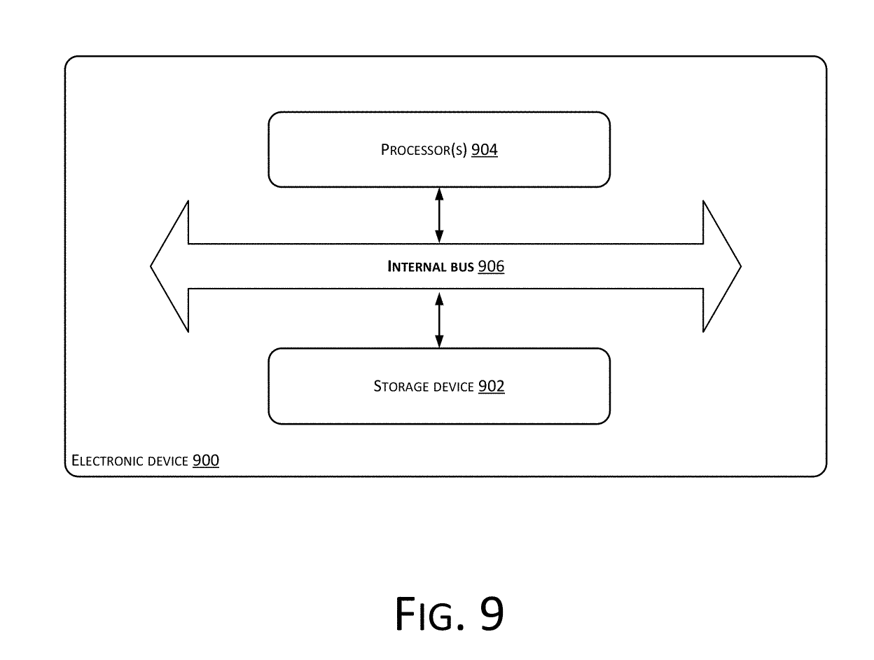

Referring to FIG. 9, the implementations of the present disclosure further provide an electronic device. The electronic device 900 includes a storage device 902, processor(s) 904, and an internal bus 906

In the present implementation, the storage device 902 includes, but is not limited to, a random access memory (RAM), a read-only memory (ROM), a cache, a hard disk drive (HHD), or a memory card. The storage device can be used for storing computer program instructions.

In the present implementation, the processor 904 can be implemented according to any suitable way. For example, the processor 904 can adopt a form such as a micro-processor or processor and computer readable media storing computer readable program instructions (e.g., software or firmware) that are executable by the (micro-)processor(s), logic gate(s), switch(es), an application specific integrated circuit (ASIC), a programmable logic controller, an embedded micro-controller, etc.

Functions that are implemented by the processor(s) 904 through an execution of the computer program include: receiving a writing request of an application program, the writing request including data to be buffered and a buffer object identifier, and the buffer object identifier corresponding to a buffer object; if the data to be buffered is media data, performing designated processing on the media data to cause the media data to possess a designated effect when being displayed; and writing the media data that has gone through the designated processing into a storage region pointed by the buffer object so that media data that is used is the media data that has gone through the designated processing when the buffer object is called.

Details of functions implemented by the storage device and the processors of the electronic device disclosed in the implementations of the present disclosure can be referenced to the foregoing implementations of the present disclosure for explanation.

The implementations of the present disclosure further provide another electronic device. The electronic device includes a storage device, and processor(s).

In the present implementation, the storage device includes, but is not limited to, a random access memory (RAM), a read-only memory (ROM), a cache, a hard disk drive (HHD), or a memory card. The storage device can be used for storing computer program instructions.

In the present implementation, the processor can be implemented according to any suitable way. For example, the processor can adopt a form such as a micro-processor or processor and computer readable media storing computer readable program instructions (e.g., software or firmware) that are executable by the (micro-)processor(s), logic gate(s), switch(es), an application specific integrated circuit (ASIC), a programmable logic controller, an embedded micro-controller, etc.

Functions that are implemented by the processor(s) through an execution of the computer program include: receiving a buffer object allocation request from an application program, wherein the buffer object allocation request includes a data type identifier, and the data type identifier is used for representing a data type of data of the application program to be buffered; and allocating a cached buffer object to the application program if the data type represented by the data type identifier is media data, wherein data stored in a storage region that is pointed by the cached buffer object first enters into a cache of a central processing unit before being processed by the central processing unit, and the central processing unit reads the data from the cache.

Details of functions implemented by the storage device and the processors of the electronic device disclosed in the implementations of the present disclosure can be referenced to the foregoing implementations of the present disclosure for explanation.

It should be noted that various implementations in the specification of the present disclosure are described in a progressive manner. The same and similar parts of the implementations can be referenced with one another. The focus of each implementation is different from those of other implementations. In particular, due to their basic similarities to method implementations, the description of server and computer readable media implementations is relatively simple. References can be made to relevant portions of the method implementations.

Furthermore, one skilled in the art can understand that one skilled in the art can come up with ideas that some or all of the implementations described in the document of the present disclosure can be combinable without the need of any creative effort after reading the specification of the present disclosure, and these combinations should also be covered in the scope of disclosure and protection of the present disclosure.

In the 1990s, a technical improvement may be clearly differentiated by hardware improvements (for example, improvements in circuit structures such as diodes, transistors, switches, etc.) or software improvements (improvements in method processes). However, with the development of technologies, many of today's method process improvements can be seen as a direct improvement in hardware circuit architectures. Designers may incorporate improved methods to hardware circuits to get the corresponding hardware circuit structures. Accordingly, a method of process improvement may be achieved with hardware entity modules. For example, a programmable logic device (Programmable Logic Device, PLD) (e.g., Field Programmable Gate Array, FPGA) is one such integrated circuit logic function performed and determined by a user to program the device. With a designer to program a digital system for “integrating” into a PLD on his/her own, it is not necessary to have a chip manufacturer to design and manufacture a dedicated integrated circuit chip. Further, by replacing manually produced integrated circuit chips, this type of programming is also mostly replaced by “logic compiler” software. Similar to a software compiler, such logic compiler compiles original codes written by a specific programming language, which is called a hardware description language (Hardware Description Language, HDL). HDL is not the only one, and there are many kinds, such as ABEL (Advanced Boolean Expression Language), AHDL (Altera Hardware Description Language), Confluence, CUPL (Cornell University Programming Language), HDCal, JHDL (Java Hardware Description Language), Lava, Lola, MyHDL, PALASM, RHDL (Ruby Hardware Description Language), etc. The most common ones are VHDL (Very-High-Speed Integrated Circuit Hardware Description Language) and Verilog. One skilled in the art should understand that a logic method flow may be achieved in hardware circuits by performing a little logic programming and compiling these methods into an integrated circuit using hardware description language.

The modules or units described in the above embodiments can be implemented by computer chips or entities, or implemented by products having certain functionalities.

For the sake of description, when the above apparatuses are described, the functions are divided into various units and described separately. Apparently, when the present disclosure is implemented, the functions of the units can be implemented in one or more software and/or hardware components.

As can be seen from the description of the above implementations, one skilled in the art can clearly understand that the present disclosure can be implemented by software with a necessary universal hardware platform. Based on this understanding, the essence of the technical solutions of the present disclosure, or portions that make contributions to the existing technologies can be manifested in a form of a software product. This computer software product can be stored in a storage media, such as ROM/RAM, a magnetic disk, an optical disk, etc., and includes instructions to cause a computing device (which can be a personal computer, a server, or a network device, etc.) to perform methods described in various embodiments or certain portions of the embodiments of the present disclosure.

The present disclosure can be used in multiple universal or dedicated computing system environments or configurations, for example, a personal computer, a server computer, a handheld device or portable device, a tablet device, a multi-processor system, a microprocessor-based system, a set-top box, a programmable consumer electronic device, a network PC, a small-scale computer, a large-scale computer, and a distributed computing environment including any of the above systems or devices.

The present disclosure may be described in the general context of computer-executable instructions executed by a computer, such as program modules. In general, program modules include routines, programs, objects, components, data structures, etc., that perform specific tasks or implement specific abstract data types. The embodiments of the present disclosure may also be implemented in a distributed computing environment. In these distributed computing environments, tasks are performed by a remote processing device connected via a communication network. In a distributed computing environment, the program modules may be located in local and remote computer storage media, including storage devices.

Although the present disclosure is described using the embodiments, one of ordinary skill in the art can understand that a number of variations and modifications exist in the present disclosure without departing the spirit of the present disclosure. The appended claims are intended to cover these variations and modifications without departing the spirit of the present disclosure.

1. A method comprising:
receiving a writing request of an application program, the writing request including data to be buffered and a buffer object identifier, and the buffer object identifier corresponding to a buffer object;
if the data to be buffered is media data, performing designated processing on the media data to cause the media data to possess a designated effect when being displayed; and
writing the media data that has gone through the designated processing into a storage region pointed by the buffer object so that media data that is used is the media data that has gone through the designated processing when the buffer object is called.

2. The method of claim 1, wherein the media data is video data, audio data, or image data.

3. The method of claim 2, wherein performing the designated processing on the media data comprises:
performing processing that increases display effects of the video data to enable the video data to possess designated visual effects when being played;
processing that increases audio effects of the audio data to enable the audio data to possess designated acoustic effects when being played; or
processing that increases display effects of the image data to enable the image data to possess designated visual effects when being displayed.

4. The method of claim 1, wherein the buffer object comprises a buffer object type identifier, the buffer object type identifier being used for representing a type of the buffer object.

5. The method of claim 4, further comprising writing the data to be buffered into a storage region pointed by the buffer object corresponding to the buffer object identifier.

6. The method of claim 5, wherein performing the designated processing on the media data comprises recognizing that the data to be buffered is the media data when the type of the buffer object represented by the buffer object type identifier is a cached buffer object, wherein data stored in the storage region pointed by the cached buffer object first enters into a cache of a central processing unit, and the central processing unit reading the data from the cache before the central processing unit performs the designated processing thereon.

7. The method of claim 1, wherein the writing request further comprises a data type identifier, the data type identifier being used for representing a data format of the data to be buffered.

8. The method of claim 7, further comprising recognizing the data type of the data to be buffered is the media data.

9. The method of claim 1, further comprising:
receiving a buffer object allocation request of the application program prior to receiving the writing request, wherein the buffer object allocation request includes a data type identifier, and the data type identifier is used for representing a data type of the data of the application program to be buffered; and
allocating the buffer object according to the data type identifier.

10. The method of claim 9, wherein allocating the buffer object according to the data type identifier comprises: allocating a cached buffer object to the application program when the data type represented by the data type identifier is the media data, wherein data stored in a cached buffer, before going through the designated processing by a central processing unit, first enters into a cache of the central processing unit and the central processing unit reads the data from the cache.

11. One or more computer readable media storing executable instructions that, when executed by a client, cause the client to perform acts comprising:
receiving a writing request of an application program, the writing request including data to be buffered and a buffer object identifier, and the buffer object identifier corresponding to a buffer object;
if the data to be buffered is media data, performing designated processing on the media data to cause the media data to possess a designated effect when being displayed; and
writing the media data that has gone through the designated processing into a storage region pointed by the buffer object so that media data that is used is the media data that has gone through the designated processing when the buffer object is called.

12. The one or more computer readable media of claim 11, wherein the media data is video data, audio data, or image data.

13. The one or more computer readable media of claim 12, wherein performing the designated processing on the media data comprises:
performing processing that increases display effects of the video data to enable the video data to possess designated visual effects when being played;
processing that increases audio effects of the audio data to enable the audio data to possess designated acoustic effects when being played; or
processing that increases display effects of the image data to enable the image data to possess designated visual effects when being displayed.

14. The one or more computer readable media of claim 11, wherein the buffer object comprises a buffer object type identifier, the buffer object type identifier being used for representing a type of the buffer object.

15. The one or more computer readable media of claim 14, the acts further comprising writing the data to be buffered into a storage region pointed by the buffer object corresponding to the buffer object identifier.

16. The one or more computer readable media of claim 15, wherein performing the designated processing on the media data comprises recognizing that the data to be buffered is the media data when the type of the buffer object represented by the buffer object type identifier is a cached buffer object, wherein data stored in the storage region pointed by the cached buffer object first enters into a cache of a central processing unit, and the central processing unit reading the data from the cache before the central processing unit performs the designated processing thereon.

17. The one or more computer readable media of claim 11, wherein the writing request further comprises a data type identifier, the data type identifier being used for representing a data format of the data to be buffered, and wherein the acts further comprise recognizing the data type of the data to be buffered is the media data.

18. The one or more computer readable media of claim 11, the acts further comprising:
receiving a buffer object allocation request of the application program prior to receiving the writing request, wherein the buffer object allocation request includes a data type identifier, and the data type identifier is used for representing a data type of the data of the application program to be buffered; and
allocating the buffer object according to the data type identifier.

19. The one or more computer readable media of claim 18, wherein allocating the buffer object according to the data type identifier comprises: allocating a cached buffer object to the application program when the data type represented by the data type identifier is the media data, wherein data stored in a cached buffer, before going through the designated processing by a central processing unit, first enters into a cache of the central processing unit and the central processing unit reads the data from the cache.

20. A client comprising:
a receiving module used for receiving a request for allocating a buffer object from an application program, wherein the request for allocating the buffer object includes a data type identifier, and the data type identifier is used for representing a data type of data of the application program to be buffered; and
a allocation module used for allocating a cached buffer object to the application program if the data type represented by the data type identifier is media data, wherein data stored in a storage region that is pointed by the cached buffer object first enters into a cache of a central processing unit before being processed by the central processing unit, the central processing unit reading the data from the cache.
